(19) United States
(12) Patent Application Publication
(10) Pub. No.: US 2021/0260710 A1
(43) Pub. Date: Aug. 26, 2021

(54) Bit Mounted Fan

(71) Applicant: Dennis G. Fitzpatrick, Bronx, NY (US)

(72) Inventor: Dennis G. Fitzpatrick, Bronx, NY (US)

(21) Appl. No.: 16/795,916

(22) Filed: Feb. 20, 2020

(51) Int. Cl. B23Q 11/00

(52) U.S. Cl. CPC B23Q 11/005

(57) ABSTRACT

The disclosed device is a fan that is threaded over a cutter, preferably over the shank of such cutter. The bearing portion of the fan is substantially shorter than the length of the shank. The fan contains at least two blades, but may contain three, four or more blades. The blades are at a perpendicular angle with respect to the sidewall of the bearing. The blades are in a horizontal, or if stated differently, in a flat orientation with the bearing. The blades may also be angular both with respect to the previously mentioned flat orientation and more or less perpendicular with respect to the sidewall.

### FIELD OF THE INVENTION

The present invention relates to an accessory to drilling or cutting equipment that is designed to clear up debris and shavings from the immediate vicinity of the cutting space.

### BACKGROUND OF THE INVENTION

Machining and manufacturing shops rely very heavily on stationary power tools such as CNC machines, routers and drill presses. These machines are used to create precision cuts, trims and openings to fashion uncut work pieces into finished projects. The cutter bits used in this work are made of hard and durable alloys. However, normal bit dulling and wear is inevitable.

Besides for the motor components of machine equipment, the cutter fittings are the next most expensive critical item. It is therefore important to present a solution that would extend the operational life of cutters by eliminating unnecessary sources of abrasion.

The cutter faces two main sources of abrasion. The first is from the object the cutter is sculpting. This is a necessary wear. The other comes from excess waste material (sawdust and chips) that remain in the cut after the cutter has made its first pass. These shavings will naturally remain at the sides of the cut and will present another source of abrasion as the cutter is continuing its sculpting progress on the work article. This is an avoidable and unnecessary abrasion.

There are presently two solutions that attempt to remove and control the shavings. One is to point an external blower at the cutting site. This requires an external air compressor and creates an extra cost. Another is to direct a vacuum intake to siphon off the access cuttings and shavings. This works but requires an external vacuum and often does not get all the waste material. This too incurs an additional cost. While these solutions may exist on some handheld power router models, they are less common on drill presses and some lower cost CNC machines. Furthermore, even if present, a vacuum or blower takes up space, increases cost of the machine, requires additional maintenance, and increases energy consumption. Since the object of the cleanup is very lightweight and loose, the required solution may similarly be lightweight and inexpensive to adopt, preferably without introducing any additional modules, power units, or vacuums.

### SUMMARY OF THE INVENTION

The disclosed device is a bearing, whose sidewall forms a tube for insertion over a shaft of a cutter bit. The sidewall of the bearing functioning as a hub for at least two blades that perpendicularly and outwardly protrude from the opposite sides of the bearing. The blades may be set substantially parallel with the linear axis of the cutter, or at a slight angle with the respect to the linear axis of the cutter. The bearing and the shaft of the bit form a snug but removable fit. The bit is then inserted into a chuck 70 (FIG. 5) as usual and spun normally for the purpose of making an appropriate cut. The bearing will then spin together with the bit without interfering with the rotation of the chuck 70 or the coming in contact with the work article.

In the embodiment shown in the figures, the two blades protrude at a length of half of an inch to two inches from the hub. This distance is sufficient for the blades to generate a very strung air current while the bearing is spinning together with the bit. This air flow creates a disturbance which scatters the shavings from the cutting area, effectively cleaning the area of the cut while the cutter is working. The energy and motion required to spin the bearing is already supplied through the chuck for the primary purpose of the machine, namely cutting, thus the disclosed fan component adds no additional overhead, save for the negligible cost of the fan formed by the bearing and blades.

The two blades are preferably made of a stiff resin or light plastic, or other stiff but brittle material, so that the bearing and blades will crumble if the blades should come in contact with the work article. The immediate destruction of the bearing is intended to limit or avoid damage to the work article being. The ring is preferably made from non-flexible materials and would come in a plurality of diameters

The disclosed ring is preferably mounted on the shank portion of the cutter, between the body of the cutter and the chuck. For straight shanks, the ring will be cylindrical. For tapered shanks the ring may be conical or may be mounted on a spindle holding a tapered shank.

The disclosed device is able to blow away debris from the work area while the cutting bit is spinning while hovering over the cutting area. The debris will continue to be cleared through a constant air flow generated by the spinning blades, which are rotating at the same revolutions as the cutter bit. There is very little risk that the blades will come into contact with cutting site since the ring is mounted over the shank and well away from the cutting area. However, even if the blades come into contact with the cutting area, the blades will be generally softer and more fragile than the object being sculpted and should shatter and fall away before any damage is caused to the work area.

### BRIEF DESCRIPTION OF THE DRAWINGS

FIGS. 1A-1D are detailed diagrams of the disclosed device.

FIGS. 2A-2C are detailed diagrams of another embodiment of the disclosed device.

FIGS. 3A and 3B are detailed diagrams of another embodiment of the disclosed device.

FIG. 3C demonstrates another embodiment of the present invention with the bearing assuming a conical shape.

FIGS. 4A and 4B is a closeup diagram of the disclosed device mounted onto a drill bit.

FIG. 5 is a contextual diagram, showing the device in action.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

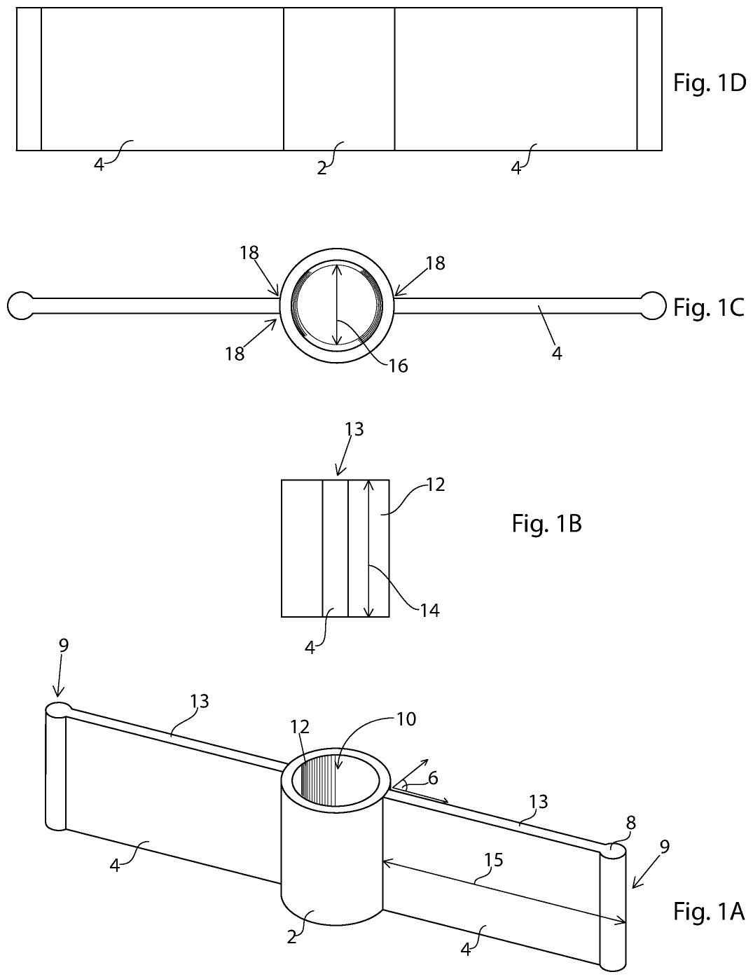

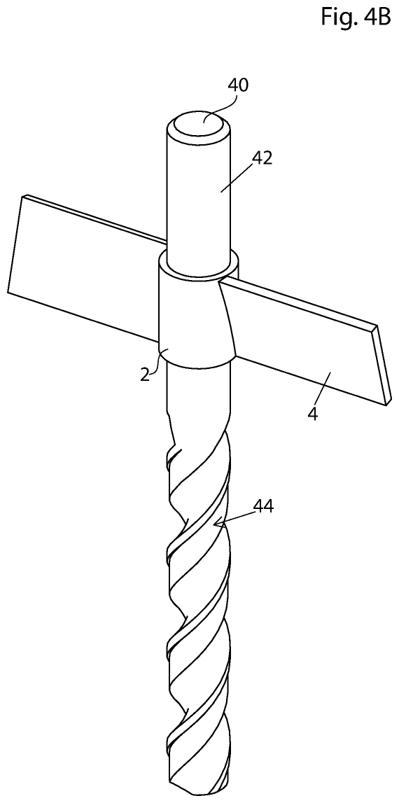

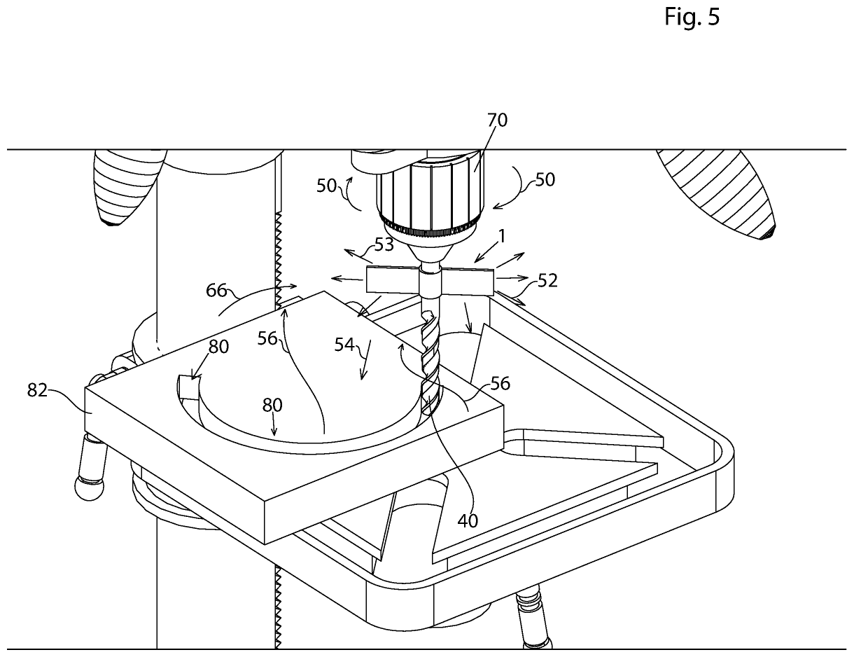

FIGS. 1A-1D demonstrate one embodiment of the disclosed fan 1, having the bearing 2 with at least two blades 4. The blades 4 are attached at right angle 6 with respect to the exterior surface of the sidewall 12. For stability, the blades 4 are attached to the opposite sides of the bearing 2. The sidewall 12 makes a hollow inner channel that is shown in form of a tube 10 with openings on both ends. While a cylindrical bearing is shown, bearing may be more conical or parallelogrammical, such that the shape of the inner channel 10 conforms with the shape of the shaft 42 (FIG. 4b.). The length 15 of each blade 4 is preferably between a half and three inches in length, with equivalent metric values. Since the rotation of the bearing 2 is at very high revolutions and the blades 4 are so close to the work article 82 (FIG. 5), the blades 4 do need to be very long to have the desired blustering effect against accumulation of shavings during a cut.

The sidewall 12 of the bearing 2 is preferably made of an inflexible material, such as hard plastic or resin. Thin walled metaling or wood materials may be used to still maintain the desired brittleness of the disclosed device. The blades 4 are made of the same or different flex-resistant material. The flex-resistance of the sidewall 12 is preferred since the blades generate substantial torque when in operation and a flexible sidewall 12 would yield under the pressure of this torque, substantially obfuscating, or even defeating the absolute perpendicularity of the blades 4 with respect to the bearing 2. Alternatively, the blade attachment points 18 may be reinforced with inflexible materials, while the rest of the sidewall remains stretchable or flexible. A flexible sidewall 12 allows a bearing of one minimum diameter 16 to assume at least two or three increasing bit diameters. A flexible bearing 2 is also capable on being mounted on cylindrical, tapered and parallelogrammical shafts 42 (FIG. 4B), without the need to have a one to one correlation of size and shape between a bearing 2 and a shaft 42. The blades 4 may be offset at a slightly more acute angle 6 in some embodiments.

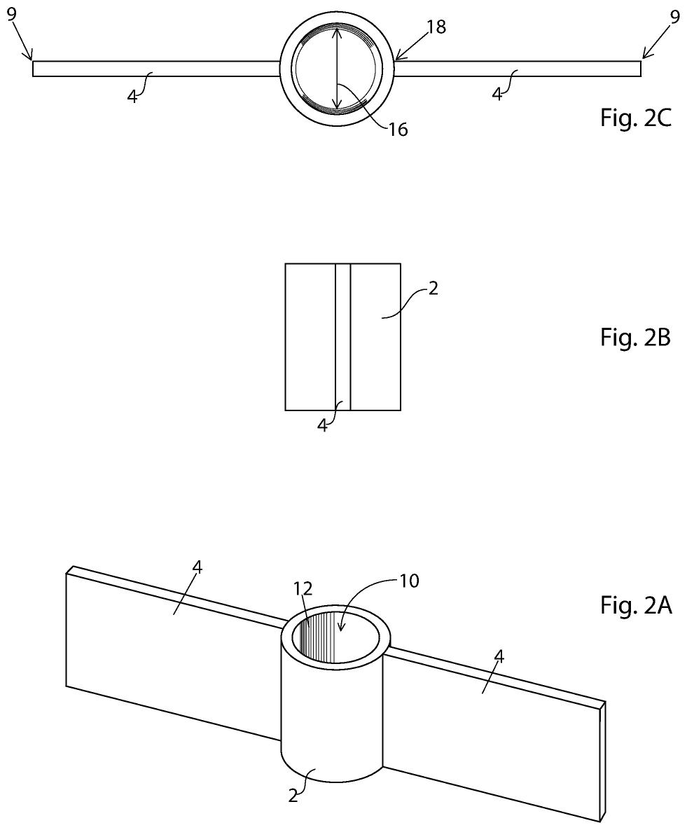

The distal ends 9 of the blades 4 may contain rigidity ribs 8 or may be of equal thickness and width, as shown in FIGS. 2A-2C. The top edge 13 is shown to be square and blunt but may also be slightly or significantly tapered to form a more acute line at edge 13. The sidewall 12 is preferably of the same height 14 as the blades 4, promoting a flush finish between the edge 13 of the blades 4 and the bearing 2, potentially lowering manufacturing costs.

The bearing 2 having a sidewall 12 will be manufactured in a plurality of widths or diameters 16 that conform to the various sizes of the drill or cutter bits on which the fan 1 will be mounted. A flexible or stretchable bearing 2 will be capable of fitting bits from a certain minimum size through larger bit sizes. The height of the bearing is preferably between ⅛ of an inch and one inch, with the length 15 of the blade 4 being between 1 and 3 inches, with similar metric values. For larger diameters and cutting bits, the fan 1 will be proportionally larger.

FIGS. 2A-2C demonstrate a variation of the disclosed bearing 2 with blades 4. In this 10 variation, the distal ends 9 are of uniform thickness as the rest of the blade surface 4. The distal end 9 may also be tapered to improve weight, balance or airflow. In other embodiments, the blades 4 may be oriented at an angle 20 from the completely horizontal plane Y. The angle 20 of the blade may be dictated by the airflow requirements. For example, an angled blade 4 will ensure that the airflow will be directed in a more concentrated and downward direction.

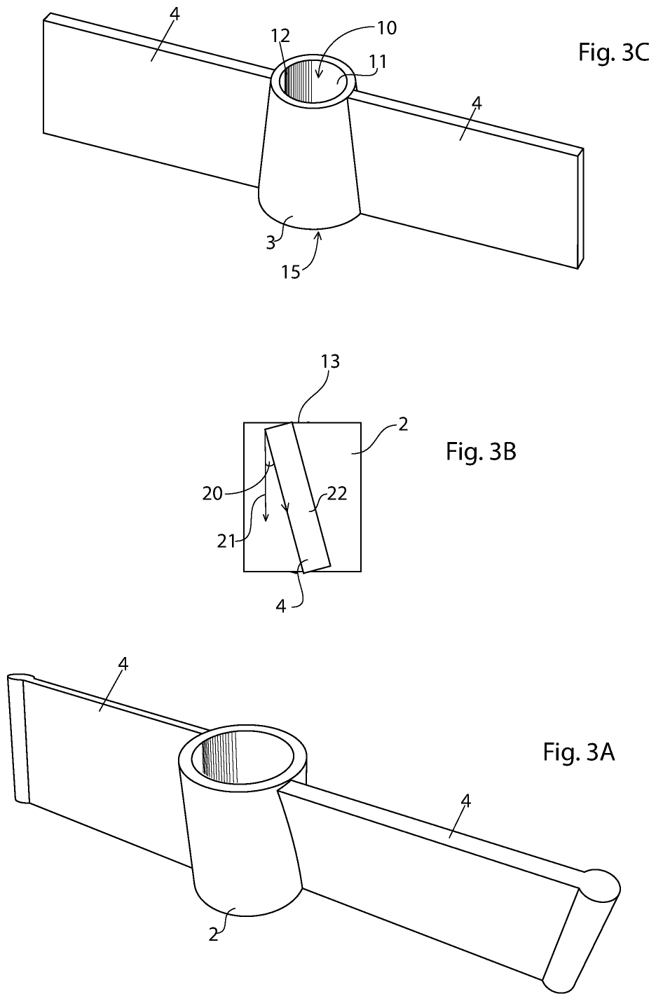

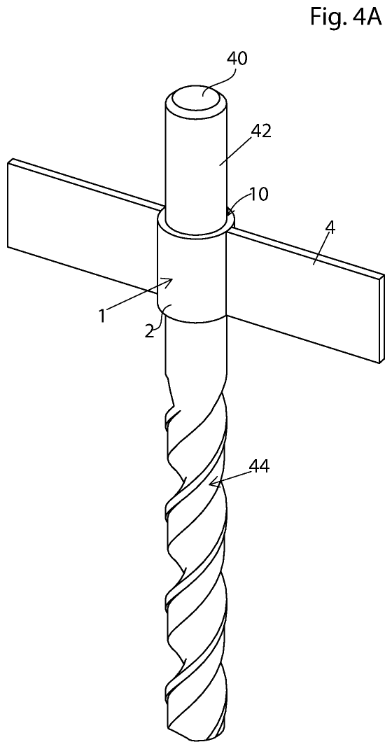

As demonstrated in FIGS. 3A and 3B, each blade 4, or any one of the blades4, may be attached at an angle 20 to the horizontal axis 21. An angled blade 4 will create a more focused air flow. If an angle 20 exists, it is preferred that the hypotenuse 22 faces the direction of rotation to produce a substantially downward airflow. FIG. 3C demonstrates a conical bearing 3 where the first opening 11 is wider than the second opening 15. A conical bearing 3 will be necessary to accommodate cutter bits with tapered shaft sections. Alternatively, a cylindrical bearing 2 may still be used, if a tapered shaft is attached to a chuck through a spindle (not shown).

In the example shown on FIGS. 4A and 4B, the optimal position for the fan 1 is on the shaft portion 42 of the bit 40. In most cases, especially with drill press machines, the shaft will rarely reach the cut area, thus the fan 1 will remain safely above the work article. Alternatively, the bearing 2 may be strung directly of the body 44 in either to get a snugger fit of the with the bearing 2 or to intensify the air flow downward towards the work article.

The utility of the disclosed device 1 is to create a sweeping air flow 52 while the chuck 79 is rotating in the clockwise direction 59 during its normal operation, as shown in FIG. 5. The blades 4 push the air in the direction 52, creating a wind force toward the sides of the bit 40. The blades 4, rotating with the chuck 70 at 500-2000 rpm, generate a very significant air flow in the lateral direction 52, downward direction 54 and upward direction 53. The airflow 52 and 54 displaces the air mass present at the cutting surface 80 of the work article 82, thus lifting shavings and other loose debris present in the upward direction 56. The spinning further causes the lifted particles to move in a concentric direction 66 around the spinning bit 40, with these particles being propelled away from the work area 80 in the direction 52. The fan 1 will maintain the airflow during the entire cutting process and keep the current area 80 clear of debris by generating a lifting and vortex-like movement motion of the shavings around the perimeter of the cut 80 and away from it. The fact that the fan 1 works in unison with the cutter 40, ensures that the desired airflow will be present where it is needed most.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A debris clearing accessory comprising, a bearing, said bearing having a sidewall, said sidewall forming an inner channel, wherein said inner channel being open on both ends;
and at least two blades, said at least two blades projecting outward from said sidewall and on the opposite side from said inner channel.

2. The debris clearing accessory of claim 1, wherein said bearing is threaded over a cutting bit.

3. The debris clearing accessory of claim 1, wherein said at least two blades are in a horizontal orientation with said bearing.

4. The debris clearing accessory of claim 1, wherein said at least two blades are in an angled orientation with respect to the horizontal orientation of said bearing.

5. The debris clearing accessory of claim 1, wherein said bearing and said at least two blades are substantially brittle.

6. The debris clearing accessory of claim 1, wherein said bearing is cylindrical.

7. The debris clearing accessory of claim 1, wherein said bearing is conical.

8. The debris clearing accessory of claim 1, wherein said bearing is comprised of a flexible material that is capable of stretching to cover a range of bearing diameters or shapes.
